(19) United States
(12) Patent Application Publication
(10) Pub. No.: US 2023/0301249 A1
(43) Pub. Date: Sep. 28, 2023

(54) PLANTER PROTECTOR

(71) Applicant: Milo Orsini, Gibsonia, PA (US)

(72) Inventor: Milo Orsini, Gibsonia, PA (US)

(21) Appl. No.: 18/123,513

(22) Filed: Mar. 20, 2023

Related U.S. Application Data
(60) Provisional application No. 63/322,304, filed on Mar. 22, 2022.

(51) Int. Cl. A01G 13/02

(52) U.S. Cl. CPC A01G 13/0212

(57) ABSTRACT

The present invention is directed to a system and device for covering all forms of indoor and outdoor planters and plant pots to prevent damage caused by water (rain and snow usually) from getting into the planters during cold weather. The device of the present invention is comprised of a cover and securing system to secure the cover to the planter when in use and that can be removed from the cover for ease of storage when not in use.

### CROSS-REFERENCE TO RELATED APPLICATION

This application claims priority to U.S. Provisional Application Serial No. 63/322,304, filed Mar. 22, 2022, which application is incorporated by reference herein in its entirety.

### BACKGROUND OF THE INVENTION

### Field of the Invention

The present invention is directed to a system and device for covering all shapes and sizes of indoor and outdoor planters and plant pots to prevent damage caused by water (rain and snow usually) from getting into the planters during cold weather. The present invention also is directed to a system and device to add a decorative element(s) to planters that do not have plants growing in them.

### Description of Related Art

It is well known that one of the steps taken to winterize any garden, plant or flower containers, planters, pots, flowerpots, raised beds, etc. (collectively herein “planter(s)”) is to remove the plants and soil from the planters and then to clean and store the planters in a dry, protected location. This protects the planters from the combination effects of moisture, rain, snow, and freezing temperatures. When water enters a planter (without or without the soil in it, but more frequently with soil) during times of dropping temperatures, the water will freeze and expand in the planter or in the soil that is in the planter. This expansion can crack the planter and damage it. This is especially important for clay and terra cotta planters because they are made of porous materials that will crack or shatter if left outside in freezing temperatures unprotected from water getting inside them.

Even for planters made of materials that can better withstand freezing temperatures, it is well known to cover the planters with some sort of plastic bag or similar device to prevent water from getting inside the planter during colder temperatures and to prevent water from collecting inside, freezing, expanding, and cracking the planters. Even sturdy plastic and fiberglass planters may crack if the moisture in the soil inside expands as it freezes, or if the planter fills with water which then the water freezes.

The present invention solves the problem of planters cracking when water gets inside of them during freezing temperatures by providing an aesthetically pleasing and simple to use cover to which attaches to the planter and/or to the soil in the planter to secure the cover to the planter. The planter protector of the present invention prevent water from entering the planter. The planter protector of the present invention also improves on existing technologies, such as U.S. Pat. No. 9,198,529 B2 (Flowerpot protector for outdoor/indoor planters) by being easy to store and move and having optional decorative elements.

### BRIEF SUMMARY OF THE INVENTION

The following presents a summary to provide a basic understanding of one or more embodiments of the invention. This summary is not intended to identify key or critical elements or delineate any scope of the particular embodiments or any scope of the claims. Its sole purpose is to present concepts in a simplified form as a prelude to the more detailed description that is presented later.

Various embodiments of the present invention include a planter protector system and/or a planter protector device for use on a planter having an upper edge. Both the system and the device have a cover, having an upper surface and an underneath surface, which is sized to extend at least to the upper edge of the planter; and a securing system that is configured to secure the cover to the planter. For some embodiments of the present invention system and device, the cover extends beyond the upper edge of the planter. Additionally, for some embodiments of the present invention system and device the cover is pitched or sloped so that water runs off the cover.

Various embodiments of the present invention include a planter protector system or a planter protector device for use on a planter having an upper edge. For some embodiments of both the system and device, the securing system is comprised of at least one stake that extends from the underneath surface into the planter to secure the cover to any soil in the planter. For other embodiments, the securing system comprises at least two strap securing devices attached to two connection points on the cover and at least one strap that is sized to connect to and run between the at least two connection points and to run underneath the planter so that the weight of the planter helps secure the planter protector system to the planter.

Any embodiment of the present invention can incorporate decorative elements. These elements can include but are not limited to the following: finials, lights, colors, shapes, textures, attached decorations, signs, words, seasonal or holiday decor, etc.

Finally, some embodiments of the present invention are drawn to a combination system, comprising a planter protector system, comprising a cover and a securing mechanism; and a planter. The cover of these embodiments can incorporate any of the elements of planter protector systems described herein. Additionally, these combination systems can incorporate any of the securing mechanism described herein. Finally, in some embodiments, the combination system’s securing mechanism can be configured so that the planter has an upper edge, and the cover is of a size and shape to extend at least to and connect with the upper edge of the cover.

### BRIEF DESCRIPTION OF THE SEVERAL VIEWS OF THE DRAWINGS

To facilitating understanding of the invention, the accompanying drawings and descriptions illustrate various embodiments thereof, from which the invention, various embodiments of its structures, construction and method of operation and many advantages may be understood and appreciated. The accompanying drawings illustrate a sample of the various embodiments of the present invention and are not the exhaustive of the numerous embodiments included within the scope of the invention. The accompanying drawings are hereby incorporated by reference.

FIGS. 1A and 1B show two embodiments of planter protectors of the present invention having three and two stakes, respectively;

FIGS. 2A and 2B show two embodiments of planter protectors of the present invention sitting on top of two different styles of planters;

FIGS. 3A through 3C illustrate three embodiments of covers of the present invention having three different heights and different degrees of sloping;

FIGS. 4A through 4H illustrate eight different underneath surfaces of the present invention, each having a different type or arrangement of attachment prongs for removable or detachable stakes;

FIGS. 5A and 5B illustrate how the covers of one embodiment of the present invention can be stacked for storage;

FIGS. 6A through 6D illustrate four possible embodiments of ornamental finials or lights attached to covers according to the present invention;

FIGS. 7A through 7D illustrate another embodiment of a planter protector system or device of the present invention designed for a planter with a circular upper edge and using stakes;

FIGS. 8A and 8B illustrate a different embodiment of planter protector system or device of the present invention designed for a planter with a rectangular upper edge and using stakes;

FIG. 9 illustrates one embodiment of an attachment mechanism;

FIG. 10 illustrate one example of a topiary-style ornamental finial;

FIGS. 11A through 11C illustrate one embodiment of a square-shaped planter protector cover with a finial attachment mechanism;

FIG. 12 illustrates one embodiment of a rectangular-shaped planter protector cover with a finial attachment mechanism;

FIG. 13 is one embodiment of a square planter protector cover with a scalloped design according to the present invention;

FIG. 14 is another embodiment of a circular planter protector cover with a scalloped design according to the present invention;

FIG. 15 is one embodiment of a circular planter protector cover according to the present invention;

FIG. 16A is a top-down view of one embodiment of a planter protector cover sitting on the upper edge of a planter and showing four possible locations of securing devices on the underneath surface of the cover;

FIG. 16B shows one embodiment of a planter protector having a securing system comprising two straps, each strap attached to two opposing sides of the cover at two opposing connection points and running underneath the planter;

FIGS. 17A through 17H show a variety of securing devices that can be used in conjunction with straps or strings to secure a cover to a planter, according to the present invention; and

FIGS. 18A and 18B illustrate a combination planter protector and planter wherein the lower edge of the planter protector secures to the upper edge of the planter.

### DETAILED DESCRIPTION OF THE INVENTION

The following describes exemplary embodiments in which the present invention may be practiced. This invention, however, may be embodied in many different ways and the description provided herein should not be construed as limiting in any way. Among other things, the following invention may be embodied as systems, methods or devices. The following detailed descriptions should not be taken in a limiting sense. The accompanying figures and drawings are hereby incorporated by reference.

In this document, the terms “a” or “an” are used, as is common in patent documents, to include one or more than one. In this document, the term “or” is used to refer to a nonexclusive “or” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the figures. However, it is to be understood that the invention may assume alternative variations and step sequences, except where expressly specified to the contrary. It also is to be understood that the specific devices and processes illustrated in the attached drawings and described in this specification are simply exemplary embodiments of the invention. Hence, specific dimensions and other physical characteristics related to the embodiments disclosed herein are not to be considered as limiting. Additionally, sizes and proportions of many elements of the present invention can be varied and still remain within the scope of the invention. Finally, while the invention is described in terms of systems and devices, the invention can be described as a method of protecting a planter and remain within the scope of the invention and this application.

While the disclosure has been described in detail and with reference to specific embodiments thereof, it will be apparent to one skilled in the art that various changes and modifications can be made thereto without departing from the spirit and scope of the embodiments. Thus, it is intended that this application covers modifications and variations of this disclosure provided they come within the scope of the appended claims and their equivalents.

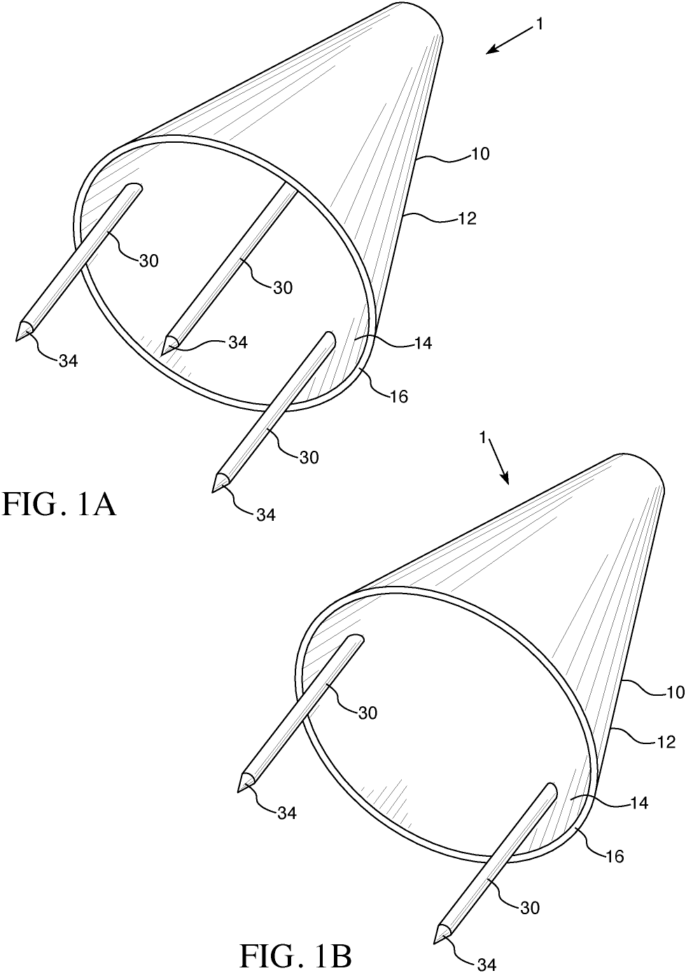

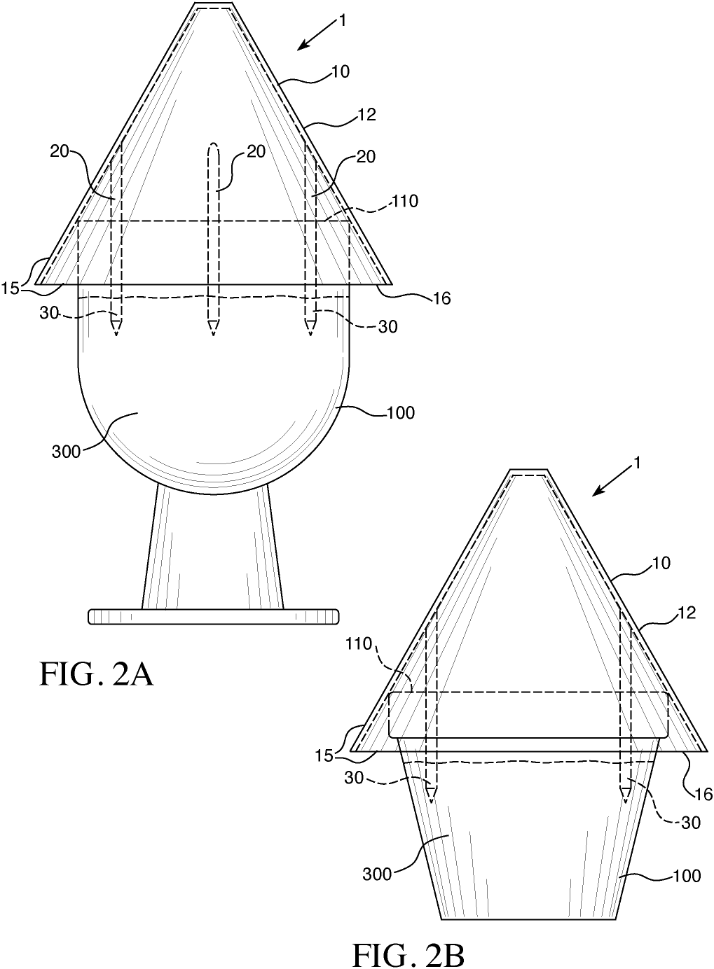

The present invention encompasses numerous embodiments and variations of a planter protector system and device 1 comprised of a cover 10 and a securing system or device 20 (see FIGS. 1A through 2B, 7B, 8B, and 16B). The cover 10 can be of any size and shape to adequately cover a planter 100 and to prevent most moisture (usually in the form of rain or snow) from entering the planter 100. In most embodiments of the present invention, the cover 10 is sized to overhang the upper edge 110 of the planter 100 to better prevent water from entering the planter 100 from above (see FIGS. 2B, 8A, 11B and 16B). As will be discussed herein, there are numerous types of securing systems 20 that can be configured to secure the cover 10 to the planter 100 (see FIGS. 1A through 2B, 4A through 4H, 7A through 7C, and 16B). A securing system 20 can be comprised of one structure or device that attaches the cover 10 to the planter 100 or it may be a plurality of structures, devices, and pieces that, together, attach the cover 10 to the planter 100. The securing system 20 is designed to prevent reasonable weather events from dislodging the cover 10 from the planter 100. Finally, the present invention also encompasses a combination planter protector and planter system 400. The following detailed descriptions and the accompanying figures illustrate some of the numerous configurations of planter protector systems and devices 1 of the present invention and any system or device 1 can be modified to contain any combination of the elements described herein to prevent, within reason, water from entering a planter 100 from above and/or to add a decorate element to a planter 100.

In preparation for cold weather, a user usually removes any plants from a planter 100, or the plants can be cut down to a height that will fit under the cover 10 of a planter protector system or device 1. Then, the planter protector system or device 1 is installed on the planter 10 to keep rain and snow out of the planter 100 during cold, inclement weather. Alternatively, as described more fully herein, decorative versions of the various embodiments of the planter protector systems and devices 1 of the present invention can be used at any time of the year and in any weather instead of planting plants in the planter 100.

In most embodiments, the cover 10 of a planter protector system or device 1 is at least as large as, but preferably slightly larger than, the planter’s upper edge 110 (as shown in FIGS. 2B, 7B, 8A, 16A and 16B, which creates an overhang 15). However, embodiments wherein the cover 10 is the same size and shape of the planter’s upper edge 110 function so long as there is a seal or secure mating of the planter’s upper edge 110 and the cover’s lower edge 16. When installed on a planter 100, the various embodiments of planter protector systems and devices 1 of the present invention eliminate or minimize the amount of water, usually in the form of precipitation, that enters the soil 300 and the planter 100 from above. By minimizing the amount of moisture inside the planter 100 during cold weather, the various embodiments of planter protector systems and devices 1 of the present invention reduce the chances that the planter 100 will crack due to water expansion and contraction.

FIGS. 2A, 2B, 11B, 16A, 16B, 18A and 18B illustrate a variety of embodiments of planter protector systems and devices 1 according to the present invention sitting on top of different styles of planters 100. In the preferred embodiments of the present invention, the cover 10 will have a cone-type shape or will be pitched or sloped (to varying degrees) to encourage snow, ice and rain to run off of the cover 10 instead of accumulating on the upper surface 12. Also, for the preferred embodiment of the present invention, the lower edge 16 of the cover 10 is slightly larger in circumference than the upper edge 110 of the planter 100 on which planter protector 1 sits and ideally extends beyond the upper edge 110 of the planter 100 (see FIGS. 2A and 2B).

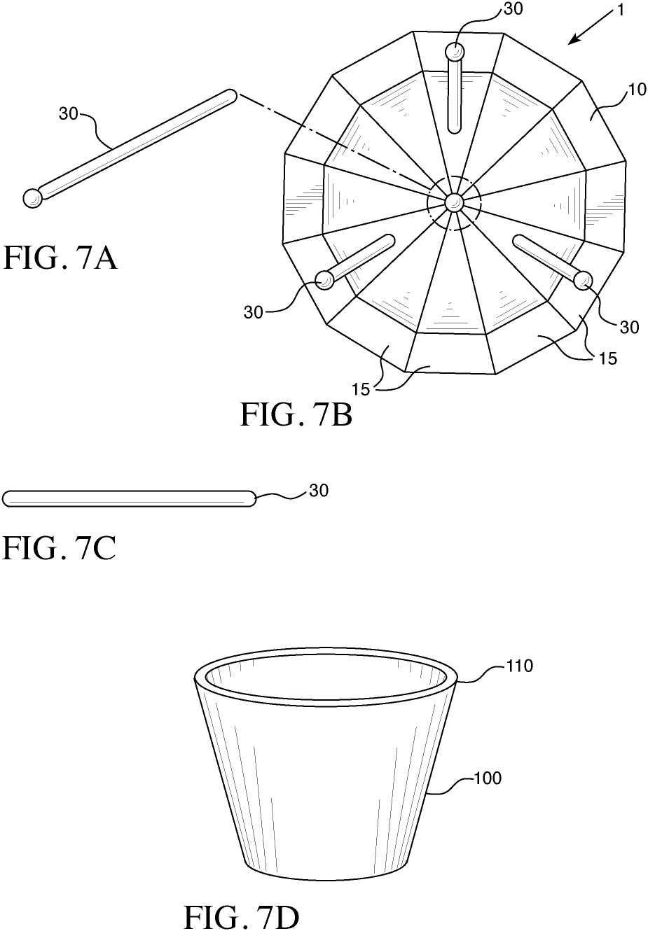

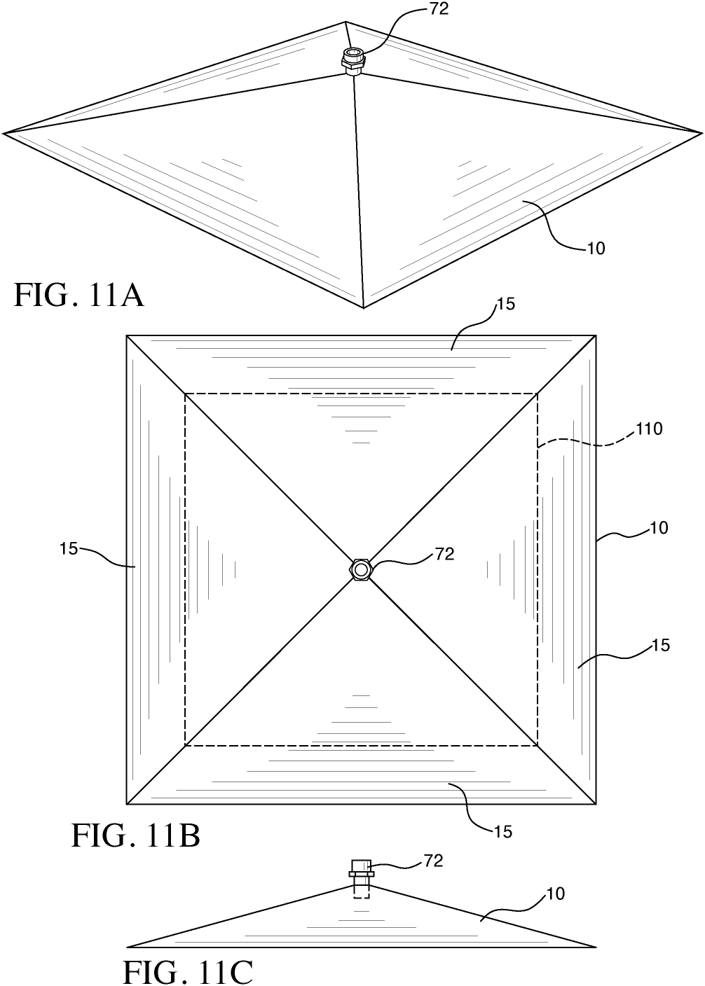

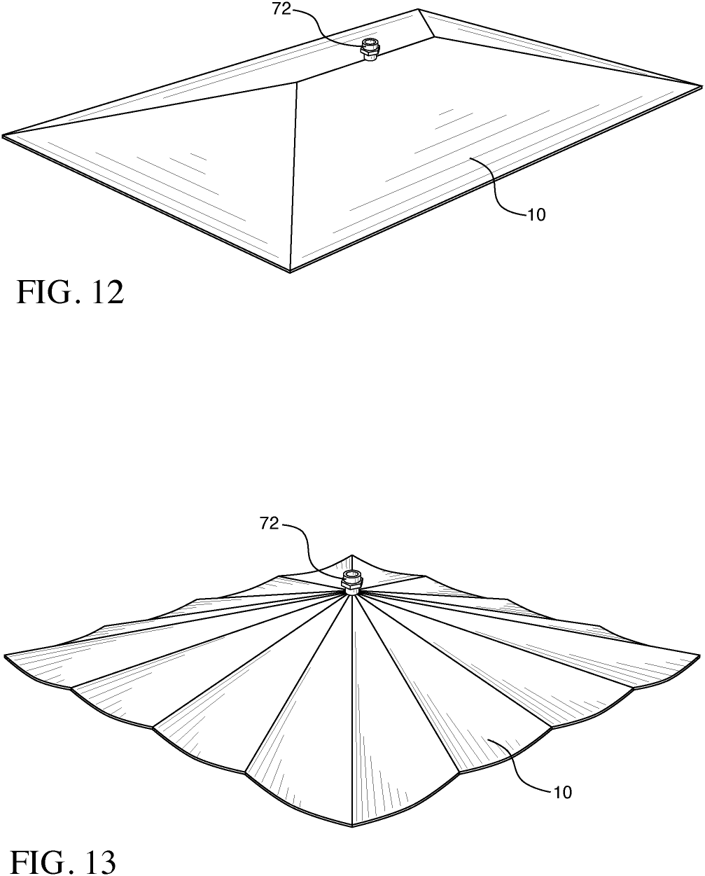

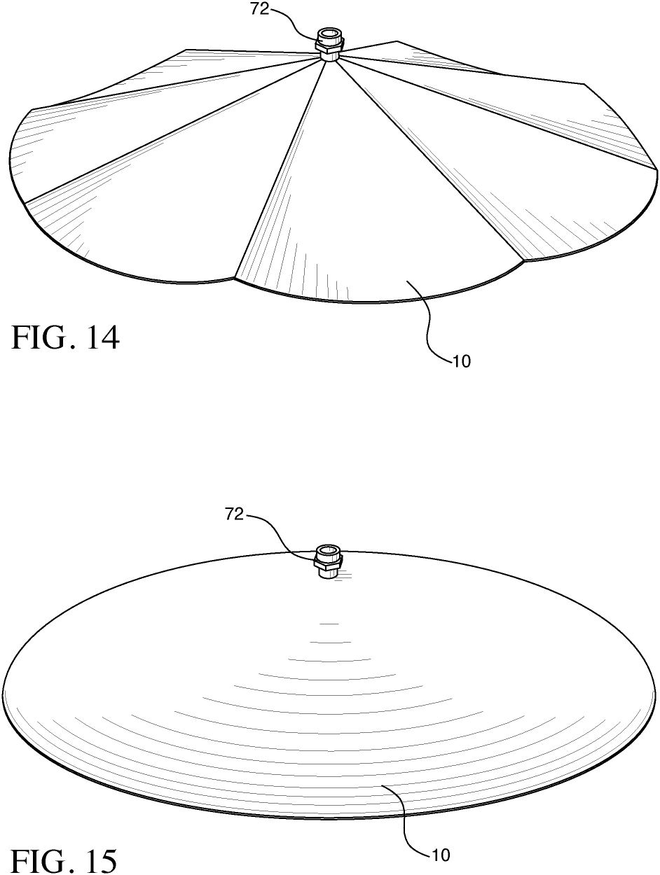

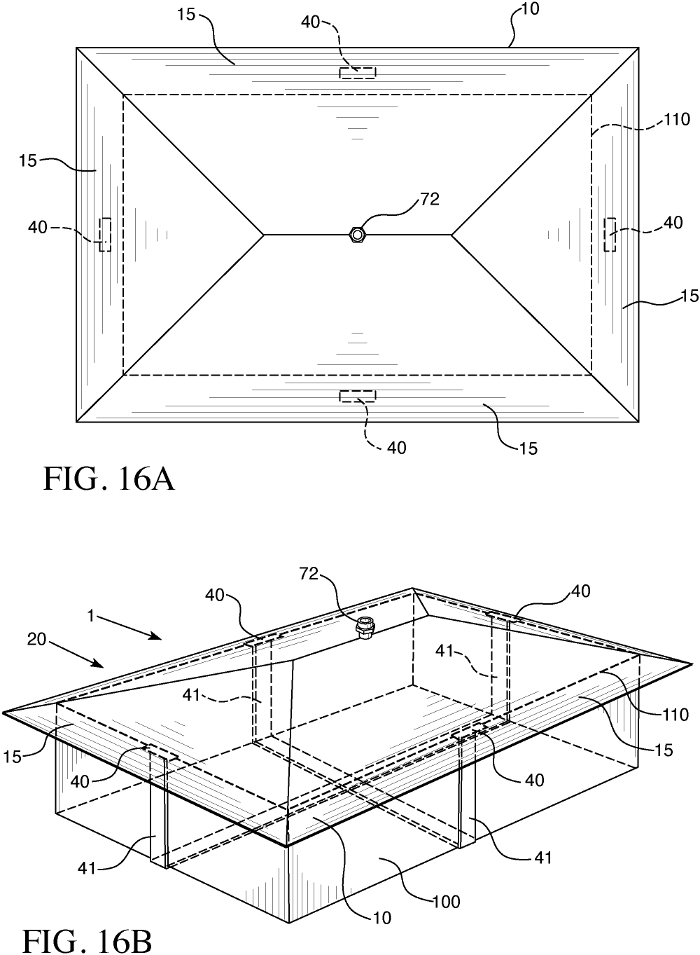

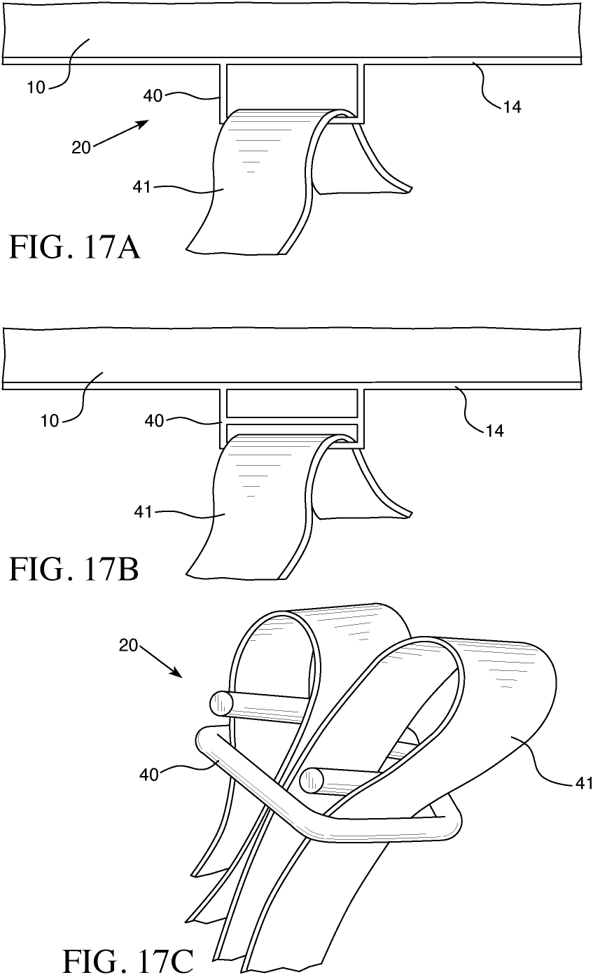

In the preferred embodiments of the present invention, the cover 10 will have a cone-style, pitched, sloped or slanted shape (see FIGS. 1A through 8A and 10 through 16B) to encourage snow, ice, rain and water to run off of the cover 10 instead of accumulating on the upper surface 12. However, other shapes will accomplish this same goal and are encompassed by the present invention. The overall shape, size, and dimensions of the various embodiments of a cover 10 of the present invention will vary widely to accommodate planters 100 of any shape and size. The accompanying figures illustrate a non-exhaustive sampling of covers 10 having a wide variety of circumferential shapes and sizes including circular (FIGS. 1A through 7B, 10, 14 and 15), rectangular (FIGS. 8A, 12, 16A and 16B), and square (FIGS. 11A through 11C and 13). The present invention also can be configured for a cover 10 having the shape of a polygon, a triangle, any similar geometric shapes with curved sides, or an asymmetrical shape. Alternative embodiments of the present invention encompass design variations on the cover 10 that would enable the cover 10 to expand, contract or change size so that one cover 10 can adapt to be used with planters 100 of a variety of sizes.

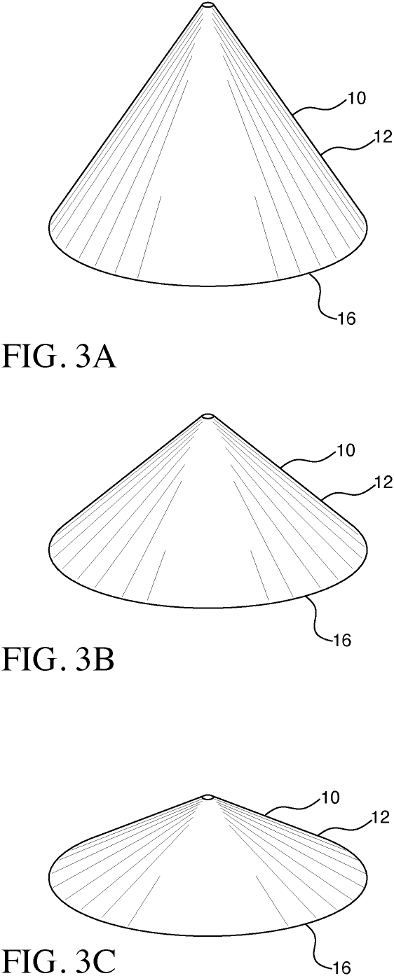

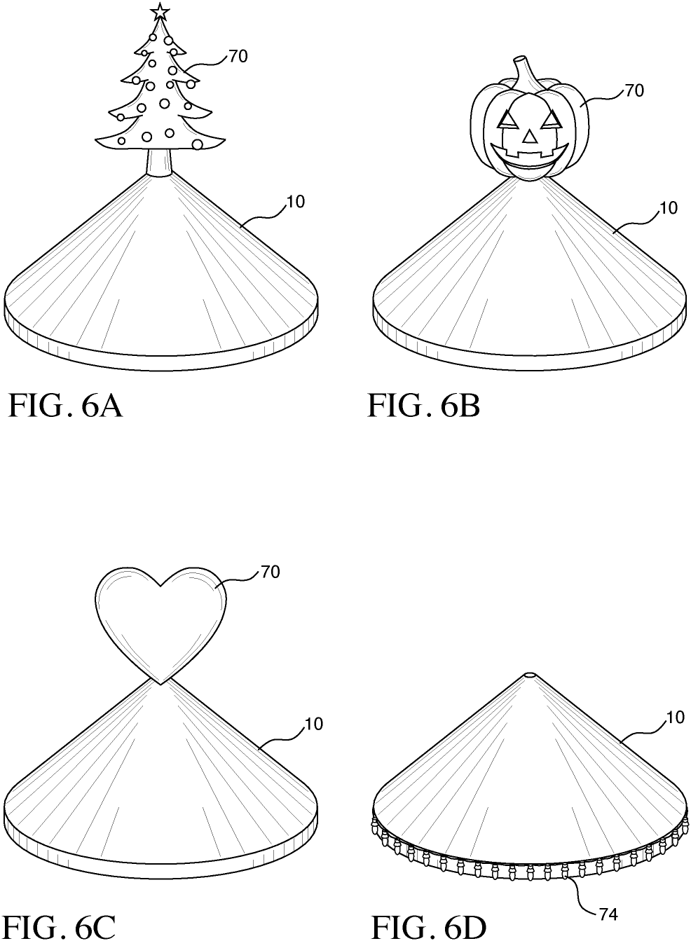

The cover 10 can be designed to have any height or have an adjustable height. FIGS. 3A through 3C illustrate three possible relative heights for covers 10 according to the present invention. As shown in FIGS. 1A through 6C, the upper surface 12 of the cover 10 of some embodiments of the present invention can have a smooth surface or it can be scalloped (shown in FIGS. 7A, 7B, 13 and 14) or otherwise variegated or textured.

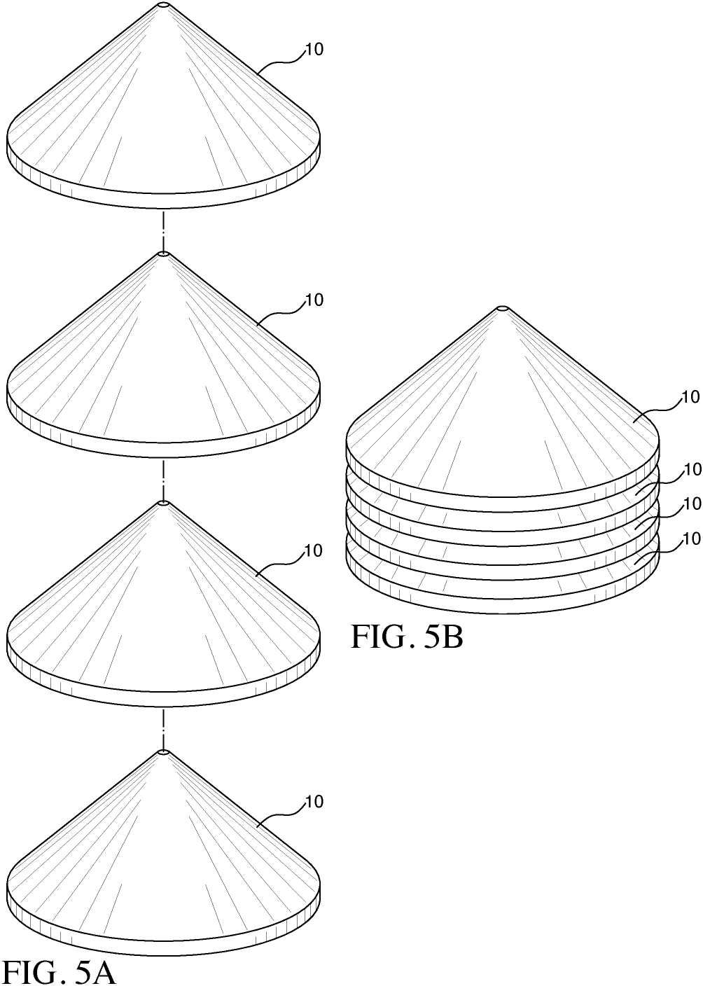

The cover 10 of the present invention can be made from any weather-resistant, firm material that will resist caving under the weight of snow or ice and will not deteriorate excessively with normal wear and tear from outdoor use. Covers 10 according to the preferred embodiment of the present invention are made from a stiff plastic. However, covers 10 for various embodiments of the present invention can be made from any treated or sealed metal, treated or sealed wood, fiberglass, a composite material, other types of plastic, or a combination of materials that meet the criteria of being reasonably weather resistant for expected use and relatively waterproof to prevent water from seeping through the cover 10 and entering the planter 100. However, any embodiment of the present invention could be used indoors or in a covered outdoor area and, for those embodiments, the covers 10 can be made of waterproof materials, water-resistant materials, or any non-waterproof or non-water-resistant material because the purpose of the covers 10 can be more decorative in nature than the need for protection from moisture. Covers 10 according to the present invention can also be made from materials of any color or painted or coated to have any color, design, pattern, decoration, or any type of texture. Covers 10 can be decorated to have seasonal themes on them, to match or to compliment the associated planter 100, or to match or complement the house or outdoor decor. There are endless options for designing aesthetically pleasing, humorous, or seasonal covers 10 that either draw attention to the planter protector systems or devices 1, complement their surroundings or blend into their surroundings (see FIGS. 6A through 6D, 10, 14 and 15.)

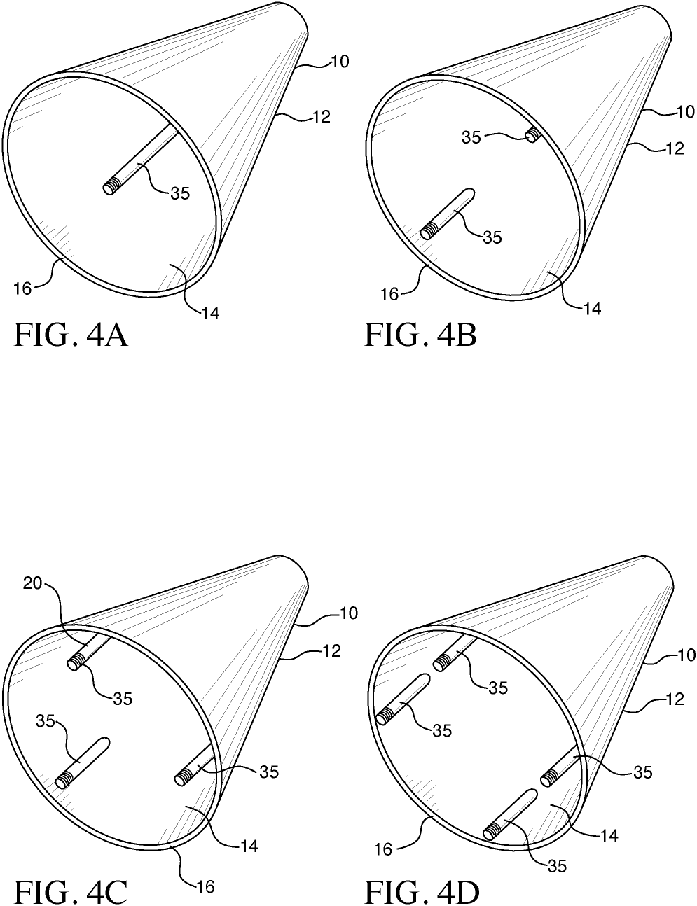

As described herein, there are numerous configurations for securing systems or devices 20 that can be combined with any of the covers 10 described herein. For example, FIGS. 1A through 2B, 4A through 4H, and 7A through 8B illustrate several embodiments of planter protector systems and devices 1 according to the present invention that incorporate one or more stakes 30 as the securing system or device 20 to secure a cover 10 to the soil 300 inside the planter 100. In those embodiments of a planter protector system or device 1 that utilize one or more stakes 30 as part or all of the securing system or device 20, the stakes 30 can be permanently or removably attached to the cover 10. FIGS. 1A and 1B illustrate permanently attached stakes 30. FIGS. 4A through 4H illustrate removably attached stakes 30. The stakes 30 enable the cover 10 to be pressed onto the planter 100 so that the one or more stakes 30 sink into the soil 300 inside the planter 100 to secure the planter protector system or device 1 against being blown or moved off of the planter 100.

For the various embodiments of planter protector systems and devices 1 of the present invention that utilize at least one stake 30 that removably connects to the underneath surface 14 of the cover 10, the stake(s) 30 have a connection end 32 and an opposite tip 34 end. The tip 34 is designed to penetrate the soil inside a planter 100, which means that the tip 34 can be pointed (as shown in FIGS. 1A through 2B) or simply be sufficiently narrow to be pushed into soil. For the removably connect stakes 30 each stake 30 connects to an attachment prong 35, which extends from the underneath surface 14 of the cover 10.

The various embodiments of stakes 30 of the present invention can be made of any of the materials that are used for the cover 10 or any other material that resists deterioration from water and soil 300 and is sufficiently strong to withstand being pushed into soil 300 without immediately bending or collapsing. The stakes 30 also can be made from multiple materials, such as composite or layered materials (e.g., a metal rod coated in plastic). Additionally, the stakes 30 of various embodiments of the present invention can have any length that extends from the underneath surface 14 of the cover 10 or from the attachment prongs 35 to the soil at a depth sufficient to resist being dislodged. For those embodiments with removable stakes 30, the user can choose a length of stake 30 that is appropriate for the size and depth of the planter 100 that they are looking to protect.

Also, for embodiments with removable stakes 30, the connection end 32 of a stake 30 of the present invention is designed to secure to an attachment prong 35 of any functional length that extends from the underneath surface 14 of the cover 10. There are a variety of attachment styles and mechanism that can be used to accomplish this as will be obvious to one skilled in the art. First, the attachment prong 35 may have a female lower end 36, which is designed to receive a male connection end 32 of the stake 30. Second, the attachment prong 35 may have a male lower end 37, which is designed to be inserted into a female connection end 32 of a stake 30. For either of these designs, the attachment prongs 35 and connection ends 32 of the stakes 30 can be threaded or unthreaded. Threaded attachment prongs 35 are shown in FIGS. 4A through 4D. Unthreaded attachment prongs 35 are shown in FIGS. 4E through 4H.

The number of stakes 30 (and, when needed, the corresponding attachment prongs 35) used with any cover 10 can vary. The accompanying FIGS. 1A through 8A show various embodiments of planter protectors 1 having one to six stakes 30. However more than six stakes 30 can be used. The number and location of stakes 30 (and corresponding attachment prongs 35) will depend upon a number of factors including but not limited to the overall size and shape of the cover 10, the sign, shape, and depth of the anticipated planter 100, the material from which the cover 10 is made, the intended use environment, the anticipated ornamental finial 70, etc.

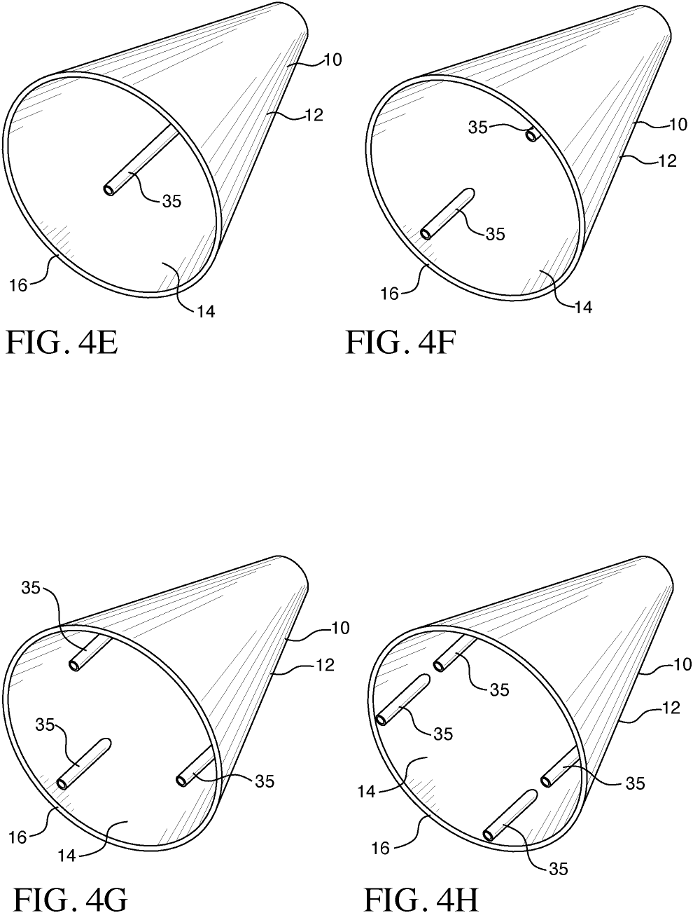

One of the advantages of the design of some embodiments of the present invention is that they facilitate easy and efficient storage of the planter protectors 1 when not in use. By separating the stakes 30 from the covers 10, both parts can be stored more efficiently and take up less storage space than if one had to store the covers 10 with the stakes 30 attached. FIGS. 5A and 5B illustrate one way in which covers 10 (without attached stakes 30) can be stacked for easy storage.

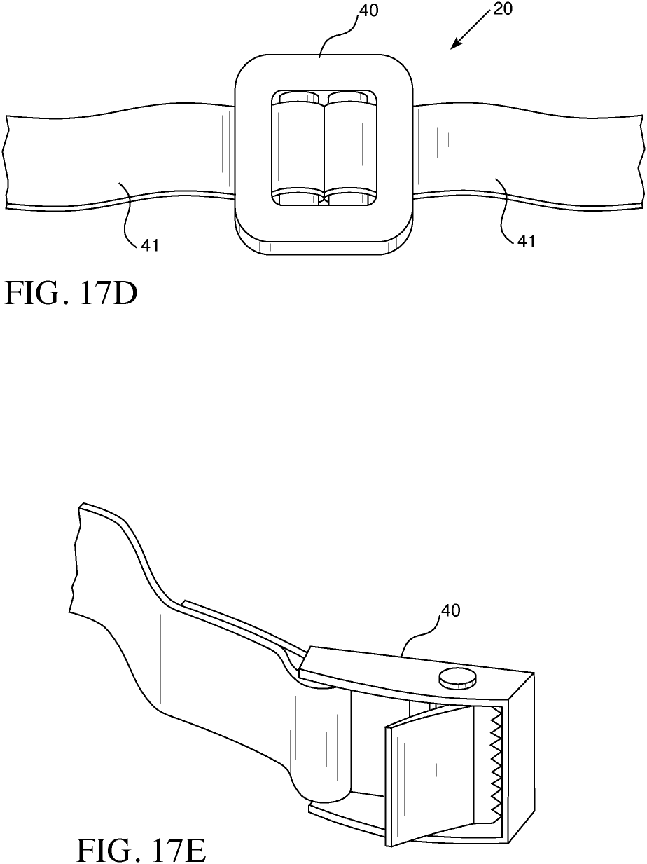

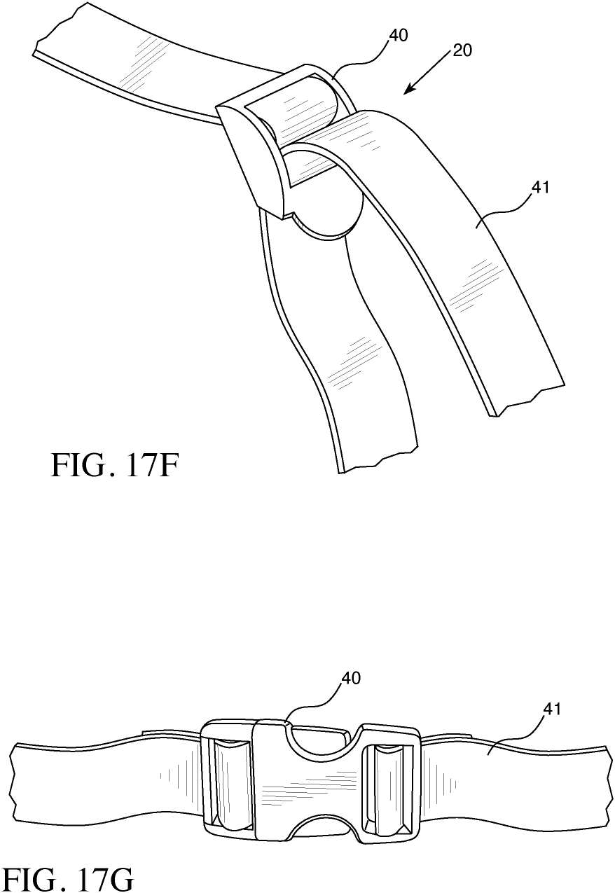

There are numerous other mechanisms, devices, and technologies that can be used individually or in combination as a securing system or device 20 for alternative embodiments of the present invention. One alternative securing system 20 for the various embodiments of the present invention is a combination of straps, cords, strings, rope, tape (collectively referred to herein as “strap(s) 41”) and at least one strap securing device 40, which strap securing device 40 is located at least one connection point 42 on the overhang 15 of the cover 10. FIG. 16A is a top-down view of a cover 10 sitting on the upper edge 110 of a planter 100. Visible in FIG. 16A are four locations (four connection points 42 along the overhang 15) for strap securing devices 40, which are attached to or are part of the underneath surface 14 of the cover 10. For these embodiments of a securing system and device 20 the weight of the planter 100 helps to secure the straps 41 and, therefore, secures the planter protector system 1. For these embodiments, the straps 41 can be made from plastic, metal, jute or other natural and weather resistant material, and any composite materials. Similarly, the strap securing devices 40 can be an extension of, or formed from the cover 10. The connection points 42 can be located anywhere along the overhang 15 of the cover 10. The overhang 15 is that portion, edge or lip of the cover 10 that extends beyond the upper edge 110 of the planter 100. Depending upon the size and shape of the planter 100, for some embodiments of the present invention the use of one strap 41 and two strap securing devices 40 is sufficient or more than two pairs of strap securing devices 40 and more than two straps 41 may be necessary.

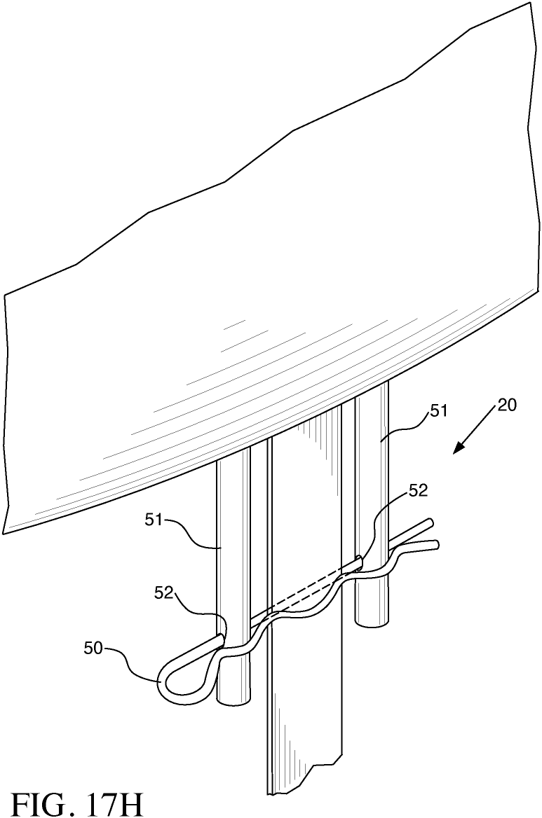

For securing systems 20 that utilize straps 41, there are a wide number of mechanisms that can be used to secure the straps 41 to the cover 10 (strap securing devices 40) at the connection point(s) 42. A selection of such strap securing devices 40 is shown in FIGS. 17A through 17H. Any device, mechanism or structure that enables a strap 41 to be securely connected to the cover 10 while enabling the strap 41 to run underneath the planter 100 can be used with the present invention. FIG. 17A illustrates a bar or rectangle that can be attached to or formed as a part of the cover 10 through which a strap 41 can be threaded and then secured. FIG. 17B illustrates device 40 similar to that shown in FIG. 17A but having the structure to enable the strap 41 to be threaded back through the device 40 to use tension or friction to secure the strap 41.

FIGS. 17C, 17D and 17F illustrate various structures that can be connected to the cover 10 and through which a strap 41 can be woven and secured. FIG. 17E illustrates a tension clamp structure that can grab and hold a strap 41 in place underneath the cover 10. FIG. 17G illustrates a buckle-style strap securing device 40 that can be used to connect the strap 41 to the cover 10. Finally, FIG. 17H illustrates a strap securing device 40 that utilizes two tabs 51 extending down from the underneath surface 14 of the cover 10. Each tab 51 has a hole 52 in it and through the holes 52 a carter pin 50 or any similar structure (such as a piece of metal or a combination of a screw and bolt, etc.) runs. The strap 41 can then be threaded around the carter pin 50 or similar structure.

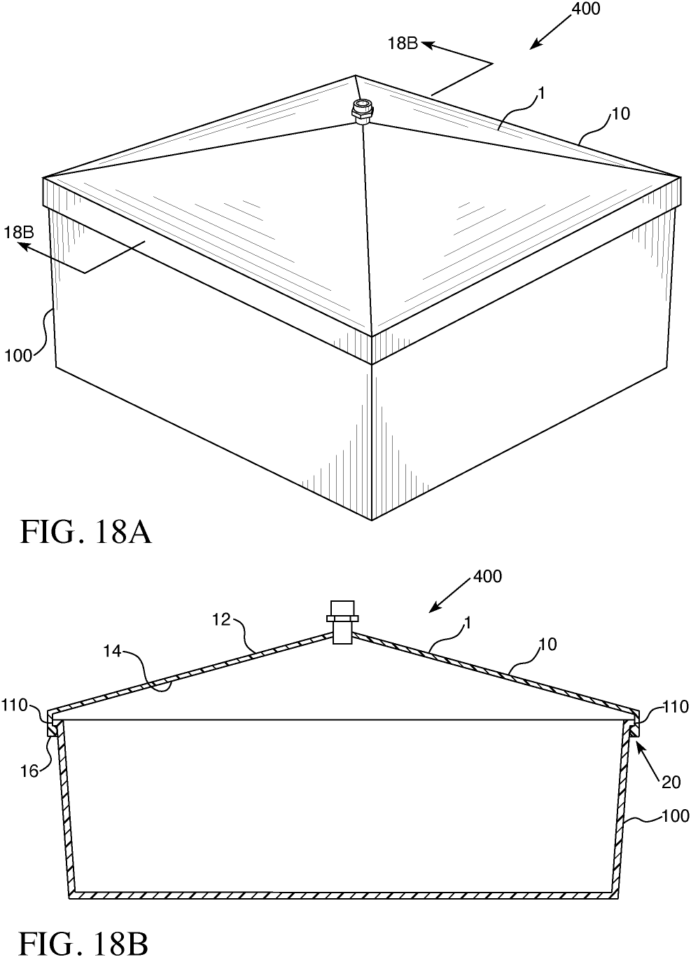

An alternative embodiment of a securing system or device 20 include clips that snap around the lower edge 16 of the cover 10 and the upper edge 110 of the planter 100. In another embodiment, the lower edge 16 of the cover 10 can be molded to fit snuggly around the upper edge 110 of the planter 100 to secure the cover 10 to the planter 100 (see FIG. 18B).

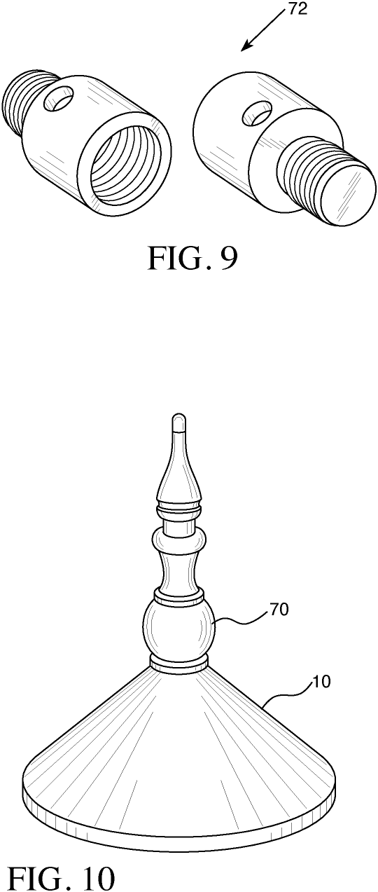

An optional addition to the planter protector systems and devices 1 of the present invention is at least one ornamental finial 70. As shown in FIGS. 6A through 6C and FIG. 10, the planter protector 1 of the present invention can be designed to be incorporated into any decor, including seasonal, holiday, aesthetic/home design preferences, etc. The planter protectors 1 of the present invention can be manufactures in any color(s) and with added elements such as ornamental finials 70 and/or lights 74. FIGS. 6A through 6C and FIG. 10 illustrate four examples of ornamental finials 70 that can be used with the planter protectors 1 of the present invention. FIG. 6A shows one embodiment of a Christmas ornamental finial 70. FIG. 6B shows one embodiment of a Halloween ornamental finial 70. FIG. 6C shows one embodiment of a Valentine’s Day ornamental finial 70. FIG. 10 illustrates one embodiment of a larger topiary-style ornamental finial 70. It will be obvious to one skilled in the art that any type/style/design of finial 70 can be created as long as it securely attaches to the cover 10 and is sized and weighted to prevent it from easily toppling the planter protector 1 off of the planter 100.

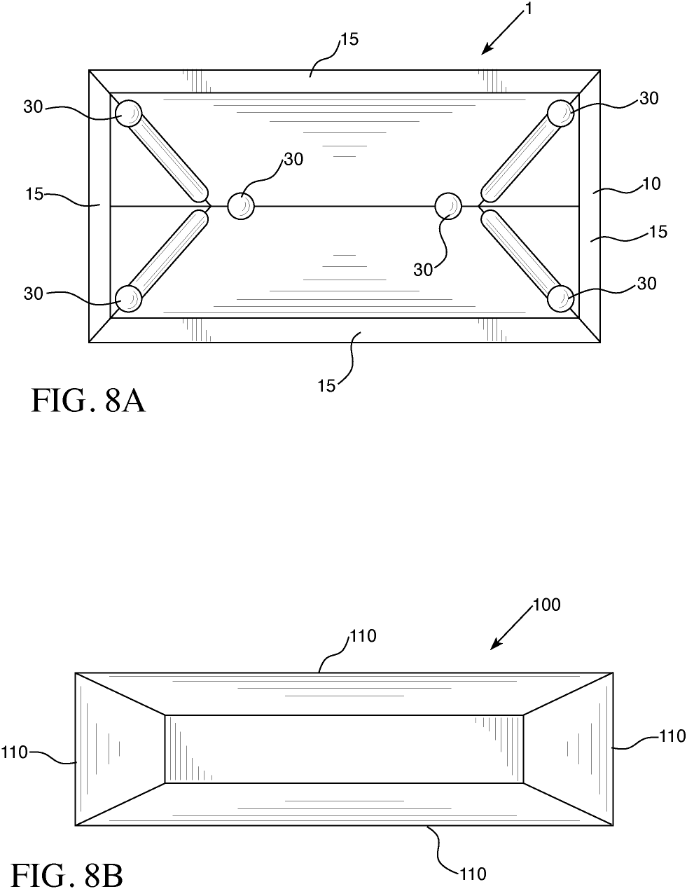

Additionally, it will be obvious to one skilled in the art that there are numerous different ways to removably connect the ornamental finials 70 to the covers 10. In the preferred embodiment, the cover 10 will have a male or female threaded attachment mechanism 72 (in most embodiments, at its center top) that will connect to a reciprocal threaded attachment piece 73 on the ornamental finial 70. This design will enable the secure connection of the ornamental finial 70 to the cover 10 while also enabling the easy removal or swapping of ornamental finials 70. FIG. 9 illustrates one type of device that can be incorporated into the cover 10 and ornamental finial 70 to facilitate the connection. FIGS. 11A through 16B illustrate a variety of covers 10 with various attachment mechanisms 72 at their centers. Alternatively, the finial 70 can be manufactured to be a non-removable element of the planter protector system or device 1.

Finally, the various embodiments of planter protectors 1 of the present invention can also incorporate light elements (battery operated, plug-in, solar, USB, rechargeable, etc.) for both illumination of the surrounding area and/or to achieve various aesthetic looks and styles. For example, Christmas lights 74 can be incorporated into Christmas themed ornamental finials 70 or covers 10. FIG. 6D illustrates one embodiment of a planter protector system 1 with lights 74 around the lower edge 16 of the cover 10. It will be obvious to one skilled in the art that lights 74 can be attached to or incorporated into any part or location on the cover 10 or finial 70 of the present invention. The lights 74 can be permanently or removable attached to the cover 10.

Finally, another embodiment of the present invention is a combination planter protector system or device 1 and a planter 100 (“combination system 400”). One embodiment is shown in FIGS. 18A and 18B. By designing and selling the planter protector system or device 1 with an associated planter 100, the combined elements can be configured to fit together like Tupperware® or Rubbermaid® containers wherein the lower edge 16 of the cover 10 and the upper edge 110 of the planter 100 can be configured to snap or sit together securely (see FIG. 18B, which is a cross-section of FIG. 18A). For some embodiments, an additional securing device 20 such as clamps, or clips can be used to further secure the cover 10 to the planter 100 for other embodiments that mating of the edges (16, 110) is sufficient to secure the planter 100 and the cover 10. The combination systems 400 can be designed and configured to look like a unified design element, or a sculptural element, when assembled and can be configured to achieve a more secure fit than separately designed and sold protector systems 1 and planters 100. Additionally, the combination 400 can incorporate any of the various covers 10, securing mechanisms 20, and decorative elements described herein.

Additional embodiments and uses for the present invention include, but are not limited to: (1) using an embodiment of a planter protector system 1 to protect plants or bulbs that are wintering over in a planter 100; (2) making the cover 10 out of a transparent or translucent material and using it over a potted plant to create a greenhouse-type effect; and (3) sinking the stakes 30 of the planter protector 1 directly into the soil in the ground to protect or help grow one or more plants that are planted in the ground instead of in a planter 100. Additionally, embodiments of planter protectors 1 according to the present invention can be designed to have clamps 70, instead of or in addition to, stakes 30 to secure the cover 10 to the upper edge 110 of a planter 100. Alternatively, embodiments of present invention can be designed to have the stakes 30 on or closer to the perimeter of the cover 10. The cover 10 in one embodiment could be designed to be the same size as or sit just within the upper edge 110 of the planter 100 as long as water could not seep between the cover 10 and the upper edge 110 of the planter 100. Finally, one embodiment of the present invention planter protector 1 can be designed with a rigid cover 10 that has a flexible edge piece 80 around the perimeter of it, which flexible edge piece 80 sits on or falls over the upper edge 110 of a planter 100 to allow a single cover 10 to fit planters 100 of different sizes. All of these embodiments are included within the scope of the present invention.

The present invention also encompasses versions of the various planter protector systems and devices 1 and combination systems 400 that are used indoors or on covered outdoor areas. In those instances, the purpose of the invention can be to add decoration to an unplanted planter 400 instead of adding protection from moisture.

While the disclosure has been described in detail and with reference to specific embodiments thereof, it will be apparent to one skilled in the art that various changes and modifications can be made therein without departing from the spirit and scope of the embodiments. Thus, it is intended that the present disclosure covers the modifications and variations of this disclosure provided they come within the scope of the appended claims and their equivalents.

What is claimed is:

1. A planter protector system for use on a planter having an upper edge, comprising:
a cover, having an upper surface and an underneath surface, which is sized to extend at least to the upper edge of the planter; and
a securing system that is configured to secure the cover to the planter.

2. The planter protector system of claim 1, wherein the cover extends beyond the upper edge of the planter.

3. The planter protector system of claim 1, wherein the cover is sloped to encourage water to run off of the cover.

4. The planter protector system of claim 1, wherein the cover is made of a material that is waterproof.

5. The planter protector system of claim 1, wherein the securing system is comprised of at least one stake that extends from the underneath surface into the planter to secure the cover to any soil in the planter.

6. The planter protector system of claim 5, wherein the stake is removably attached to the cover.

7. The planter protector system of claim 1, wherein the securing system comprises:
at least two strap securing devices each attached at a connection point on the cover; and
at least one strap that is sized to connect to and run between the at least two strap securing devices and wherein the connection points are located so that the at least one strap runs between the connection points and underneath the planter so that the weight of the planter helps secure the planter protector system to the planter.

8. The planter protector system of claim 1, also comprising at least one ornamental finial attached to the cover.

9. The planter protector system of claim 1, also comprising lights attached to the cover.

10. A planter protector device for use on a planter having an upper edge, comprising:
a cover, having an upper surface and an underneath surface, which is sized to extend at least to the upper edge of the planter; and
a securing system that is configured to secure the cover to the planter.

11. The planter protector device of claim 10, wherein the cover extends beyond the upper edge of the planter.

12. The planter protector device of claim 10, wherein the cover is sloped to encourage water to run off the cover.

13. The planter protector device of claim 10, wherein the cover is made of a material that is waterproof.

14. The planter protector device of claim 10, wherein the securing system is comprised of at least one stake that extends from the underneath surface into the planter to secure the cover to any soil in the planter.

15. The planter protector device of claim 14, wherein the stake is removably attached to the cover.

16. The planter protector device of claim 10, wherein the securing system comprises:
at least two strap securing devices each attached at a connection point on the cover; and
at least one strap that is sized to connect to and run between the at least two strap securing devices and to run underneath the planter so that the weight of the planter helps secure the planter protector system to the planter.

17. The planter protector device of claim 10, also comprising at least one ornamental finial attached to the cover.

18. The planter protector device of claim 10, also comprising lights attached to the cover.

19. A combination system, comprising:
a planter protector system, comprising a cover and a securing mechanism; and
a planter.

20. The combination system of claim 19 wherein the planter has an upper edge, and the cover is of a size and shape to extend at least to the upper edge of the planter.
